(19) United States
(12) Patent Application Publication
(10) Pub. No.: US 2024/0320132 A1
(43) Pub. Date: Sep. 26, 2024

(54) TEST ENVIRONMENT FOR URBAN HUMAN-MACHINE INTERACTION

(71) Applicant: AVL List GmbH, Graz (AT)

(72) Inventor: Christian SCHYR, Heidelberg (DE)

(21) Appl. No.: 18/659,862

(22) Filed: May 9, 2024

Related U.S. Application Data
(63) Continuation-in-part of application No. PCT/AT2022/060388, filed on Nov. 9, 2022.

(30) Foreign Application Priority Data
Nov. 9, 2021 (AT) A50891/2021

(51) Int. Cl. G06F 11/36; G06F 11/34; G06T 7/20; G06T 7/70; G06V 40/20

(52) U.S. Cl. CPC G06F 11/3684; G06F 11/3457; G06F 11/3664; G06T 7/20; G06T 7/70; G06V 40/20; G06T 2207/30196

(57) ABSTRACT

The invention relates to a method for operating a test bench for vehicles using simulation means and a motion capture system, comprising the following steps: generating a virtual test environment with at least one virtual living being and at least one virtual vehicle using the simulation means, wherein one of the virtual living beings is a virtual representation of a real living being and wherein one of the virtual vehicles is a virtual representation of a vehicle with a driver assistance system, wherein additionally at least parts of the vehicle are operated as a real test specimen on the test bench, wherein the driver assistance system is operated, particularly stimulated, based on the virtual test environment; stimulating the real living being in the motion capture system based on the generated virtual environment using a stimulus; capturing motion data using the motion capture system, wherein the motion data describe a temporal course of the pose of at least one part of an anatomical structure of the real living being; and recording the captured motion data.

### CROSS-REFERENCE TO RELATED APPLICATIONS

The present application is a continuation-in-part of International Application PCTAT2022/060388, entitled “Test environment for urban human-machine interaction,” filed on Nov. 9, 2022, which is specifically incorporated by reference for all that it discloses or teaches.

### SUMMARY OF THE DISCLOSURE

The invention relates to a method for operating a test bench for vehicles using simulation means and a motion capture system, a method for operating a test bench, a system for operating a test bench, a computer program, and a computer program product.

### BRIEF DESCRIPTION OF THE DRAWINGS

FIG. 1 illustrates a block diagram of a first exemplary embodiment of a method for operating a test bench;

FIG. 2 illustrates a block diagram of a second exemplary embodiment of a method for operating a test bench;

FIG. 3 illustrates an example of scenarios in the virtual test environment;

FIG. 4 illustrates an exemplary embodiment of a system for operating a test bench; and

FIGS. 5a to 5e illustrates example embodiments of various components of a system for operating a test bench and the test bench itself.

### DETAILED DESCRIPTION

Autonomous or semi-autonomous vehicles are equipped with a variety of sensors and algorithms that convert the signals from the sensors into a representation of the environment.

In addition to systems serving primarily for driving safety, such as ABS (Anti-lock Braking System) and ESP (Electronic Stability Program), a variety of driver assistance systems are offered in the passenger car and commercial vehicle sectors.

Driver assistance systems, which are already used to increase active traffic safety, include a parking assistant, an adaptive cruise control (ACC), which adaptively adjusts a desired speed chosen by the driver to a distance from a preceding vehicle. A further example for such Driver assistance systems are ACC stop-and-go systems, which in addition to ACC, effect automatic continuation of the vehicle in traffic jams or when vehicles are stationary, lane-keeping or lane-assist systems that automatically keep the vehicle in the lane, and pre-crash systems that prepare or initiate braking, for example, in the event of a possible collision, to dissipate the kinetic energy from the vehicle and, if necessary, initiate further measures if a collision is unavoidable.

These driver assistance systems increase both safety in traffic by warning the driver in critical situations and up to initiating autonomous interventions to prevent or reduce accidents, for example by activating an emergency braking function. In addition, driver comfort is increased by functions such as automatic parking, automatic lane-keeping, and automatic distance control.

The safety and comfort gain of a driver assistance system is only positively perceived by vehicle occupants if the support provided by the driver assistance system is safe, reliable, and as comfortable as possible, to the extent possible.

Furthermore, each driver assistance system must, depending on its function, manage traffic scenarios occurring in traffic with maximum safety for its own vehicle and also without endangering other vehicles or other road users.

The respective degree of automation of vehicles is divided into so-called automation levels 1 to 5 (cf. for example standard SAE J3016). The present invention relates in particular to vehicles with driver assistance systems of automation levels 3 to 5, which are generally considered highly automated (3 and 4) or autonomous (5) driving.

The challenges for testing such systems are manifold. In particular, a balance must be found between test effort and test coverage. The main task in testing ADAS/AD (ADAS—Advanced Driver Assistance System; AD—Autonomous Driving) functions is to demonstrate that the function of the driver assistance system is guaranteed in all imaginable situations, especially in critical driving situations. Such critical driving situations are somewhat dangerous because a lack of response or an incorrect response from the respective driver assistance system can lead to an accident.

So far, tests that test the behavior of driver assistance systems with respect to persons are carried out with dummies. Dummies are generally representations of average usually male humans in terms of anatomical size ratios and proportions. Dummies are not only expensive but also difficult to handle, and therefore can only provide results on the behavior of driver assistance systems once and not particularly realistically.

From the prior art, it is known to use real test driving data from a real fleet of test vehicles to validate and verify driver assistance systems and to extract scenarios from the recorded data.

Furthermore, document GB 2563400 discloses a method for testing vehicles and their algorithms in situations involving pedestrians.

It is the object of the invention to provide an improved method for operating a test bench, an improved method for operating a test bench using simulation means, as well as corresponding systems, computer programs, and computer program products. In particular, it is an object of the invention to achieve a realistic representation of living beings and their movement patterns.

This object is achieved by the independent claims. Advantageous embodiments are claimed in the dependent claims.

A first aspect of the invention relates to a method for operating a test bench for vehicles using simulation means and a motion capture system, the method comprising the following steps:

Generating a virtual test environment with at least one virtual living being and at least one virtual vehicle using the simulation means, wherein one of the virtual living beings is a virtual representation of a real living being and one of the virtual vehicles is a virtual representation of a vehicle with the driver assistance system, additionally operating at least parts of the vehicle as a real test specimen on the test bench, operating the driver assistance system based on the virtual test environment, particularly stimulating it. The real vehicle can be operated at least partially as a specimen on a test bench.

Furthermore, the method comprises stimulating a real living being in the motion capture system based on the generated virtual environment using a stimulus and capturing motion data using the motion capture system, wherein the motion data describe a temporal course of the pose of at least one part of an anatomical structure of the real living being.

Furthermore, the method includes recording the captured motion data. In particular, the method may include operating a test bench with a virtual test environment.

A second aspect of the invention relates to a method for operating a test bench using simulation means, particularly according to a first aspect of the invention, the method comprising:
generating a virtual test environment with at least one virtual living being and at least one virtual vehicle using the simulation means, wherein one of the virtual living beings is a virtual representation of a real living being and one of the virtual vehicles is a virtual representation of a vehicle with a driver assistance system. The vehicle, also known as the ego object or ego vehicle, which is a virtual representation of the vehicle with the driver assistance system, is operated at least partially as a specimen on a test bench. In other words, at least parts of the vehicle are operated as a real specimen on a test bench. The driver assistance system is operated based on the virtual test environment, particularly stimulated.

Furthermore, the method involves capturing motion data, particularly by means of a motion capture system. The motion data describe or represent a temporal course of the pose of at least one part of an anatomical structure of a real living being.

The method further includes recording a scenario resulting from a reaction of the driver assistance system to the captured motion data, wherein the captured motion data and a reaction of the driver assistance system to the virtual living being are taken into account when generating the virtual test environment.

Preferably, the method further includes generating test scenarios for testing a driver assistance system for vehicles.

A third aspect of the invention relates to a system for operating a test bench for vehicles, which is particularly configured and/or provided for performing a method, particularly a method according to the above aspects.

The system preferably comprises simulation means, which are configured to generate a virtual test environment with at least one virtual living being and at least one virtual vehicle, wherein one of the virtual living beings is a representation of a real living being and one of the virtual vehicles is a virtual representation of a vehicle with a driver assistance system, additionally operating at least parts of the vehicle as a real specimen on the test bench and operating, particularly stimulating, the driver assistance system based on the virtual test environment.

Furthermore, the system preferably comprises a motion capture system for capturing motion data, wherein the motion data describe a temporal course of the pose of at least one part of an anatomical structure of a real living being.

The system preferably further comprises stimulation means, wherein the stimulation means are configured to stimulate the real living being in the motion capture system based on the generated virtual environment using a stimulus. Furthermore, the system preferably comprises storage means for recording the captured motion data.

A fourth aspect of the invention relates to a system for operating a test bench, particularly according to a system of the third aspect, comprising:

simulation means, configured to generate a virtual test environment with at least one virtual living being and at least one virtual vehicle. One of the virtual living beings is a virtual representation of a real living being. Furthermore, one of the virtual vehicles is a virtual representation of a vehicle with a driver assistance system.

The system is further configured to operate the vehicle additionally at least partially as a real specimen on the test bench and to operate, particularly stimulate, the driver assistance system based on the virtual test environment. Furthermore, the system comprises means, particularly a motion capture system or an interface, configured to capture motion data, wherein the motion data describe a temporal course of the pose of at least one part of an anatomical structure of a real living being.

Furthermore, the system comprises storage means for recording a scenario resulting from a reaction of the driver assistance system to the captured motion data, wherein the captured motion data and a reaction of the driver assistance system to the virtual living being are taken into account when generating the virtual test environment.

A fifth aspect of the invention relates to a system for operating a test bench. The system includes simulation means (11), configured to generate a virtual test environment with at least one virtual living being (2′) and at least one virtual vehicle (3′), wherein one of the virtual living beings (2′) is a virtual representation of a real living being (2) and wherein one of the virtual vehicles (3′) is a virtual representation of a vehicle with the driver assistance system, wherein additionally at least parts of the vehicle (3) are operated as a real test specimen on the test bench (1), and for operating, in particular stimulating, the driver assistance system on the basis of the virtual test environment; a motion capture system (12) for capturing motion data, the motion data describing a time history of the pose of the at least one part of an anatomical structure of the real living being (2); stimulation means (13) arranged to stimulate the real living being (2) in the motion capture system (12) on the basis of the generated virtual environment by means of a stimulus; and storage means (14) for recording the captured motion data.

In some implementations, the fifth aspect of the invention additionally includes a memory means (14) for recording a scenario resulting from a reaction of the driver assistance system to the captured motion data, and a software module that generates the virtual test environment and that takes a reaction of the driver assistance system to the virtual living being (2′) are taken into account when generating the virtual test environment.

A system and/or means according to the present invention can be designed both hardware- and software-wise, in particular comprising at least one, preferably connected to a memory and/or bus system, processing unit, particularly a microprocessor or microprocessor unit (CPU), graphics card (GPU) or the like, and/or one or more programs or program modules. The processing unit may be configured to execute commands implemented as a program stored in a memory system, to capture input signals from a data bus and/or to output signals to a data bus. A memory system may comprise one or more, in particular different, storage media, in particular optical, magnetic, solid-state, and/or other non-volatile media. The program may be configured to embody or execute the methods described herein, such that the processing unit can execute the steps of such methods and thus preferably operate and/or monitor a device.

The term means as used herein extends to any structure, material or act set forth herein and any equivalents thereof. Further, the structures, materials or acts and equivalents thereof include everything described in the abstract, the brief description of the figures, the detailed description, the abstract and the claims themselves. A system and/or means thereof may preferably take the form of a hardware-only embodiment, a software-only embodiment (including firmware, resident software, microcode, etc.), or a combination of software and hardware aspects, commonly referred to as a “circuit”, “module” or “system”. Any combination of one or more computer readable media may be used. The computer-readable medium may be a computer-readable signal medium or a computer-readable storage medium.

The systems and methods according to the present disclosure may preferably be used in conjunction with a suitably equipped computer, a programmed microprocessor or microcontroller and one or more peripheral integrated circuit elements, an ASIC or other integrated circuit, a digital signal processor, a hardwired electronic or logic circuit, such as a discrete logic circuit, or an integrated circuit. A programmable logic device or gate array, such as a programmable logic device (PLD), a programmable logic array (PLA), a field programmable gate array (FPGA), a programmable logic array (PAL), or a comparable means, may be implemented. In general, any apparatus or means capable of implementing the methodology set forth herein may be used to implement the various aspects of the present disclosure. Exemplary hardware includes computers, handheld devices, telephones (e.g., cellular, Internet-enabled, digital, analog, hybrid, and others), and other hardware known in the art. Some of these devices include processors (e.g., a single or multiple microprocessors), memory, non-volatile storage, input devices, and output devices. In addition, alternative software implementations, including, but not limited to, distributed processing or distributed processing of components/objects, parallel processing, or virtual machine processing, may be developed to implement the methods described herein.

A fifth aspect of the invention relates to a computer program or computer program product, the computer program or computer program product containing instructions, particularly stored on a computer-readable and/or non-volatile storage medium, which, when executed by one or more computers or in particular a system for operating a test bench for vehicles, cause the computer or computers or the system to carry out a method for operating a test bench for vehicles using simulation means and a motion capture system, particularly according to embodiments as described above.

A computer program product may in one embodiment comprise or be a, in particular computer-readable and/or non-volatile, storage medium for storing a program or instructions or with a program or instructions stored thereon. In one embodiment, executing this program or these instructions by a system or control, in particular a computer or an arrangement of several computers, causes the system or control, in particular the computer(s), to execute a method or one or more of its steps described herein, or the program or instructions are configured to do so.

A scenario, in the context of the invention, is preferably formed from a temporal sequence of, especially static, scenes. These scenes describe, for example, the spatial arrangement of at least one object, particularly at least one virtual living being, relative to the ego object, especially the constellation of traffic participants and/or especially the constellation of immovable virtual objects, virtual living beings, particularly virtual traffic participants. A scenario may especially include a driving situation in which a driver assistance system controls at least partially the ego vehicle, referred to as the ego vehicle, equipped with the driver assistance system, for example, autonomously performing at least one vehicle function of the ego vehicle.

Regarding the motion data of at least one part of an anatomical structure of a real living being in the context of the invention, it is preferably understood that the smallest part of the body of the real living being, which is movable by a joint and/or a muscle, is represented by the motion data, and these motion data describe a temporal evolution of this smallest part. In particular, it can be made possible that at least essentially all possible movements of a real living being are recorded and represented by motion data and can be represented in the virtual test environment by the virtual representation of the real living being.

A driving situation, as understood in the invention, preferably describes the circumstances that must be considered for selecting suitable behavioral patterns of the driver assistance system at a certain point in time. A driving situation is therefore preferably subjective, representing the view of the ego vehicle. It preferably further encompasses relevant conditions, possibilities, and influencing factors of actions. A driving situation is preferably derived from the scene through a process of information selection, based on transients, such as mission-specific, as well as permanent goals and values.

In the context of the invention, driving behavior preferably refers to the behavior of the driver assistance system through action and reaction in the vehicle's environment. Quality, as defined by the invention, preferably characterizes the simulated scenario.

A quality within the meaning of the invention preferably characterizes the simulated scenario. A quality is preferably understood to be a quality or nature of the simulated scenario in terms of its suitability for testing the driver assistance system. A more critical scenario has preferably a higher quality. Preferably, the dangerousness of a driving situation, which emerges from the respective scenario for the tested driver assistance system, is a measure of the quality of the scenario.

A pose, as understood in the invention, is the spatial position, especially the combination of position and orientation, of an object, particularly a part of an anatomical structure of a living being. The pose can especially refer to a separately movable anatomical part of the living being, which can be captured, especially in the overall context of the pose of the living being, with a motion capture system. Capture can especially occur through stereo cameras, infrared tracking, image recognition, or similar systems, especially motion capture systems and methods for motion capture in a particularly three-dimensional volume.

A motion capture system, as understood in the invention, can especially capture motion with markers, especially with active or passive markers, or without markers, especially through pattern recognition, silhouette tracking, and/or the like. The motion capture system can especially be connected to a test bench in data communication, especially wirelessly or wired. The motion capture system can be spatially separated from the test stand.

Notably, a primary objective in developing a driver assistance system (DAS) is to create a system capable of providing autonomous intervening responses that control the behavior of a vehicle in a manner that reduces likelihood of accident in dangerous driving situations (critical scenarios). Driver assistance systems are commonly backed by physical and empirical models as well as by machine learning models. These models, particularly the machine learning models, are adapted and trained to predict control actions most likely to reduce the likelihood of vehicular accidents and to execute those control actions at appropriate times.

In DAS systems designed for implementation in human-operated vehicles (as opposed to entirely autonomous vehicles), it is desirable to limit responses of the DAS to those that are necessary to ensure driver safety without usurping a driver's control of the vehicle significantly more than necessary. For example, a human driver may be annoyed or even distracted by a DAS that routinely acts to override the driver's controls actions (e.g., by interfering with the driver's decisions to brake, accelerate, turn, etc.). For this reason, some DAS systems are trained to predict the actions of a human driver and to limit interventions to scenarios when such predictions indicate the driver is likely to make a bad driving decision, such as by performing a dangerous control action or otherwise failing to react appropriately to avoid an accident.

In order to train a DAS system to accurately predict the reactions of a human driver in various driving scenarios, the DAS system may be provided with training data that documents aspects a driving environment (e.g., with video data or depth mapping depicting real or virtual environments) and that further documents a human driver's reaction to various stimuli in the driving environment (e.g., video, voice, or biometric data of the human driver). In some training scenarios, a training dataset additionally includes event data captured by various sensors on a vehicle. To exemplify how this training data could be used, consider a dataset including the above components that is captured while a user that is making a right-hand turn. Further assume a rabbit jumps off the sidewalk in the far right-hand-side of the driver's field-of-view while the driver is making the right-hand turn. To avoid the rabbit, the driver steers the vehicle slightly to the left. At the same time that the driver is looking to the right and veering the vehicle slightly to the left, another vehicle speeds by very close to the center lane and the two cars collide because the driver was looking at the rabbit on the right instead of the approaching traffic on the left. A video recording of the driver's movements in this scenario could be used as a datapoint to help teach a DAS system to intervene if the driver is looking away from an oncoming vehicle while actively steering toward the oncoming vehicle.

The performance accuracy of DAS systems is limited, at least in part, by the quantity and quality of training data that is used to “teach” the underlying model(s) how (and whether) to respond in any given driving scenario. A quality training dataset is one that documents a large number of critical scenarios characterized by diverse environments, diverse moving stimuli within those environments, and different types of possible human reactions to each of those different environments and stimuli.

In existing systems, DAS training data is largely collected from test vehicles manned by real drivers. However, a quality DAS testing and/or training dataset is one that includes a large number of critical scenarios, many of which may correspond to rare chains of causally-related events that include difficult-to-repeat combinations of human driving errors and environmental stimuli. Because human errors do not occur at high frequency in test scenarios using real drivers, it is difficult to create a realistic, high-quality training dataset that is representative of dangerous human errors that can be made in various critical driving scenarios. For example, it can take hundreds or thousands of test hours to record a statistically significant number of critical scenarios in vehicle test environments manned by human drivers.

The invention is based on the idea of creating a realistic virtual representation of real living beings in the testing operation of a vehicle with a driver assistance system. By recording motion data of a human test subject operating controls of a test bench—either alone or in association with recorded aspects of a virtual driving environment—a database can be created. In one implementation, the motion data in the database is used to create new training scenarios that were not captured by the test bench. For example, the motion data may capture various poses of the driver (e.g., head direction, relaxed or rigid posture, relaxed or clenched hand position) that were each originally recorded in association with a particular set of stimuli that the driver observed in a real or virtual test environment. Within the database, the recorded motion data can be combined and/or supplemented with other motion data. The recorded motion data can especially form a motion atlas, which serves as the basis for motion simulations of virtual living beings or avatars.

In one implementation, the above-described motion data is used to create test events for a DAS system. Each test event includes motion data that includes one or more recorded poses of the driver and virtual simulation data that includes one or more virtual stimuli. The virtual stimuli that is included within the virtual simulation data of a given test event may differ from actual stimuli that the real-life driver was reacting to at the time that the motion data of the test event was recorded. If, for example, the motion data of the test event was recorded during a virtual simulation involving a human driver, the virtual stimuli of the test event may not have been presented to the human driver during the virtual simulation. Alternatively, the test event may include motion data of the virtual simulation that is shifted temporally in time relative to the presentation of corresponding stimuli within the virtual simulation.

In one implementation, motion data of a human driver is recorded during a real or simulated test scenario and used to construct test events for a DAS. Each test event includes a human pose captured within or based on the motion data and further includes virtual stimuli that may or may not have co-occurred (e.g., overlapped temporally) with the human pose in the corresponding test scenario. In different implementations the above-described types of test events can be forged various ways, such as manually (e.g., by a database operator), algorithmically, or via a trained model.

In one implementation, a database is populated with motion data and virtual events (e.g., video clips including virtual stimuli), as generally described above. The motion data and virtual events are then combined in various ways to generate test events that are then strung together to create chains of events used to test and/or train a DAS system.

Notably, the above-described methodology makes it possible to develop a DAS training dataset that includes a higher proportion of critical scenarios than the proportion of critical scenarios that are naturally observed in environments with real human drivers. A training dataset developed using the herein-disclosed techniques is therefore more effective at training a DAS to appropriately respond in critical scenarios than a training dataset that exclusively includes motion data of human drivers captured in real-life driving environments. Additionally, the herein-disclosed techniques can be used to develop a high-quality training dataset in a small fraction of the time that it would take to capture a similar total number of critical scenarios in simulations that involve real vehicles and real human drivers.

Additionally, the invention can create a test environment that enables testing or optimizing a driver assistance system for interactions with living beings. Furthermore, situations can be depicted that would be dangerous for interactions between real vehicles and real living beings, especially for at least one living being. In other words, it enables the generation of potentially life-threatening situations for living beings, especially iterating with minor changes to the motion data, which are preferably computer-generated or calculated, so that a driver assistance system can be optimized and/or trained. This can especially improve the quality of the virtual test environment, especially the scenario, especially in relation to living beings.

In an advantageous embodiment, the captured motion data can be linked with the stimulus for the real living being in the motion capture system, and the stimulus associated with the captured motion data can also be stored. In a further advantageous embodiment, the captured motion data and a reaction of the driver assistance system to the captured motion data can be considered when creating the virtual test environment.

In a further advantageous embodiment, the recorded scenario can be linked with the captured motion data, and the motion data associated with the resulting scenario can also be stored.

In a further advantageous embodiment, captured motion data can be repeatedly considered when creating the virtual test environment.

This allows motion data to be recorded only once and/or allows a temporal course of a pose, outside a range in which the motion capture system can capture movements, to be repeated with the motion data, especially in the virtual test environment, which can be larger than the detectable volume of the motion capture system. Advantageously, this can allow the motion capture system to be designed smaller than the virtual test environment and still enable motion data of real living beings to be represented by the virtual simulation (representation) of the real living being in the virtual test environment.

By associating the captured motion data with at least one, particularly visual, haptic, and/or auditory stimulus, it becomes possible for the motion atlas to store reactions and/or interactions of a real living being, especially with the ego object, situationally. These can especially include a direct interaction of the living being with the ego object, preferably touching, pushing, or the like, and can especially stimulate the real living being in the motion capture system through corresponding interfaces such as haptic gloves. Furthermore, the captured motion data can include: a distance of the ego object from the virtual living being in the virtual test environment, the positions of objects in the virtual test environment and/or their temporal derivatives, such as especially a speed or an acceleration, data on parts of the ego object or on the entirety of the parts encompassed by the ego object.

The repetition of captured motion data in the virtual test environment can especially refer to motion data representing the course of the pose of at least one part of an anatomical structure of the real living being. The repetition of the captured motion data can especially allow a changed stimulus to be generated for the driver assistance system by repeating the temporal course of the pose at a different location or at the same location in the virtual test environment. Advantageously, this can enable the driver assistance system to optimize its reaction to stimuli being repetitive and/or occurring at different locations in the virtual test environment, in particular similar stimuli. In particular, this can enable poses, in particular poses that are typically perceived as unusual, or temporal courses of, in particular unusual, poses, to be repeated, preferably as a stimulus or stimuli for the driver assistance system. The repetition of the captured motion data in the virtual test field can enable the driver assistance system to be trained (better) compared to non-repeatable motion data, especially with a machine learning method.

The variation space of possible scenarios is generally spanned by many dimensions, for example, various road properties, the behavior of other traffic participants, weather conditions, etc. Motion data can add another dimension. From this nearly infinite and multidimensional parameter space, it is particularly relevant for testing driver assistance systems to extract parameter constellations for particularly critical scenarios that can lead to unusual or dangerous driving situations. This can especially be delimited by linking the motion data with at least one stimulus.

In a further advantageous embodiment, the test specimen can be operated as hardware-in-the-loop, especially as vehicle-in-the-loop.

This can enable the hardware of the test specimen to react to scenarios in the virtual test environment and, on the other hand, enable the virtual test environment to react to the hardware of the test specimen. Advantageously, the “loop” can be operated in real-time. This allows the hardware of the test specimen to be tested and/or optimized under real-time conditions.

In a further advantageous embodiment, the capturing can be linked with at least one, especially a visual, haptic, and/or acoustic stimulus for the living being in the motion capture system from the virtual test environment.

A motion capture system can be designed in such a way that one or more stimuli, especially one stimulus or multiple different stimuli, can be presented or played to the real living being in the motion capture system simultaneously. These stimuli can be directed, especially when it comes to acoustic stimuli, such as an acoustic stimulus from one or more directions that is or can be locatable for the real living being or essentially non-locatable acoustic stimuli, especially low-frequency stimuli.

This allows motion data to be clustered, especially with their connections. This advantageously allows a scenario with, especially clustered, motion data to be modified, in particular, to generate variations of test scenarios, especially of the virtual test environment.

In a further advantageous embodiment, the repeated consideration of the captured motion data, especially the repetition of the captured motion data, can involve changing at least one part of the anatomical structure. Alternatively, or additionally, the repetition of the motion data can involve changing the temporal course of the pose of at least one part of the anatomical structure.

This enables the virtual living being to be adapted to different manifestations of at least one part of the anatomical structure, which may occur biologically in real living beings comparable to the real living being. Furthermore, by changing the temporal course of the pose, it can be enabled that a part of a movement can be emphasized, especially accelerated or slowed down. This advantageously allows the driver assistance system to be trained and/or optimized for various manifestations of movement, especially temporal courses of a pose.

In an advantageous embodiment, a change in at least one part of the anatomical structure can be performed based on the empirical quantile of the part of the anatomical structure.

This can enable a scenario, especially to be adapted to the form of appearance of at least one part of the anatomical structure according to an empirical quantile of real living beings, especially according to a corresponding percentile of at least one part of the anatomical structure. This can especially enable a variety of virtual living beings to be generated with a capture of motion data, especially for a scenario and/or a variety of scenarios. An empirical quantile is a statistical concept used to divide a dataset into equal portions based on rank or order. Specifically, it represents the value below which a certain proportion of the data falls. For example, the median is the empirical quantile that divides the data into two equal parts, with 50% of the data falling below it and 50% above it. Within the present disclosure, the empirical quantile characterizes the percentage of real living beings, in particular humans, or the of the population that have a certain anatomical structure, e.g. body height, body width, leg length, arm length, etc.

In a further advantageous embodiment, a time course of the virtual test environment during repeated consideration, especially during the repetition, of the motion data may be faster or slower than the temporal course of the motion data or faster or slower than real-time. This can especially enable, if the time course is slower than real-time, for example computationally intensive simulations to be performed, especially finite element simulations for structural optimization, numerical fluid mechanics simulations for shape optimization, or thermodynamic simulations for system optimization.

This allows, in particular, a better understanding of the scenario in the test environment and/or an adjustment or setting of the driver assistance system to be improved. Furthermore, mechanical and/or constructive configurations/changes to the ego object in relation to living beings can be tested and/or especially tested by simulation(s). Furthermore, a changeable time course of the virtual test environment can especially enable a variety of scenarios to be tested, especially a variety of variations of a scenario, especially with changes in the temporal course of the pose of a virtual living being.

In a further advantageous embodiment, the repeated consideration, especially the repetition, further includes: repeated consideration, especially repetition, of second captured motion data that differ from the first captured motion data, when generating the virtual test environment.

This can especially enable repetitions in motion sequences with different components to be introduced into the scenario. In particular, a gesture can be repeated with another gesture in different combinations. This can enable, especially, the driver assistance system not to be trained or optimized for a specific temporal course of a pose, but rather for the driver assistance system to be confronted with different temporal courses of poses and especially optimized accordingly.

In a further advantageous embodiment, the method may further comprise, in particular the following steps: determining transition data from the first captured motion data to the second captured motion data, wherein the transition data describe a temporal and/or spatial transition from the first captured motion data to the second captured motion data.

Furthermore, the method may comprise: reproducing the transition data temporally between the first captured motion data and the second captured motion data in the virtual test environment.

This can especially enable motion data that represent temporally unrelated pose sequences to be combined and/or displayed in the virtual test environment. In particular, this can enable motion data that have not been captured or recorded contiguously in the motion capture system to be combined. Advantageously, this can enable motion data from different real living beings to be combined, especially from a combination of two or more motion data to one, especially for an observer and/or the virtual representation of a vehicle, especially for the ego object, which is at least partially operated as a test specimen on a test stand, in the virtual test environment, overall motion of a virtual living being in the virtual test environment.

In a further advantageous embodiment, the method comprises that the first captured motion data and the second captured motion data can be randomly combined.

This can especially enable the driver assistance system to be optimized and/or trained on, especially unusual, movements that are randomly combined from the first captured motion data and second captured motion data. Alternatively, the first captured motion data and the second captured motion data can be combined based on combinations of the first captured motion data and the second captured motion data, especially the combination of the first captured motion data and the second captured motion data can be based on machine learning. In particular, machine learning can enable first motion data and second motion data to be combined in a way that corresponds to a natural movement of the real living being. Advantageously, this can enable especially motion data to be combined that have been captured at different locations with motion capture systems and are associated with preferably different real living beings, however preferably of the same species. In particular, the method may comprise adjusting captured motion data from different real living beings in such a way that the captured motion data can be displayed in the virtual test environment as motion data of the virtual living being and are adapted in such a way that the motion data correspond to the anatomical conditions of the virtual living being. This can be done in particular by a machine learning method.

In a further advantageous embodiment, the method may further include that a test engineer can trigger a repetition of captured motion data. This allows a test engineer to intervene in the virtual test environment and/or individually modify, adjust, and/or manipulate a scenario. This can especially be temporal and/or spatial.

A test engineer, as defined in the invention, is preferably an engineer who can move and/or intervene in the virtual test environment using a system of virtual reality, augmented reality, or mixed reality. The test engineer can especially place, remove, and/or manipulate objects in the scenario, especially both temporally and spatially.

In a further advantageous embodiment of the method, the recording of the scenario may include parameters of the scenario, depending on the type of driver assistance system to be tested, selected from the following group: speed, especially initial speed, of the vehicle; trajectory of the vehicle; lighting conditions; weather conditions; road conditions; number and position of static and/or dynamic objects, especially virtual living beings, especially with respect to the vehicle; speed and direction of movement of the dynamic objects, especially motion data of the virtual living beings; state of signal systems, especially of light signal systems; traffic signs; vertical elevation, width, and/or drivability of lanes, lane layout, number of lanes; critical infrastructure such as obstructive structural parts.

The features and advantages described above with respect to the first aspect of the invention apply correspondingly to the further aspects of the invention, and vice versa. Further features and advantages result from the following description with respect to the figures.

Step 101 relates to generating a virtual test environment, step 102 to stimulating a real living being, step 103 to capturing motion data, and step 104 to recording the captured motion data.

The method 100 can be repeated according to an exemplary embodiment, as illustrated, so that in particular new and/or modified test scenarios can be generated for testing a driver assistance system.

The method 100 comprises in particular the stimulation 102 of a real living being based on the generated virtual environment, the capturing 103 of motion data with a motion capture system, and recording, in particular storing, 104 the captured motion data, wherein the captured motion data are linked with at least one stimulus for the real living being 2 in the motion capture system 12 from the virtual test environment.

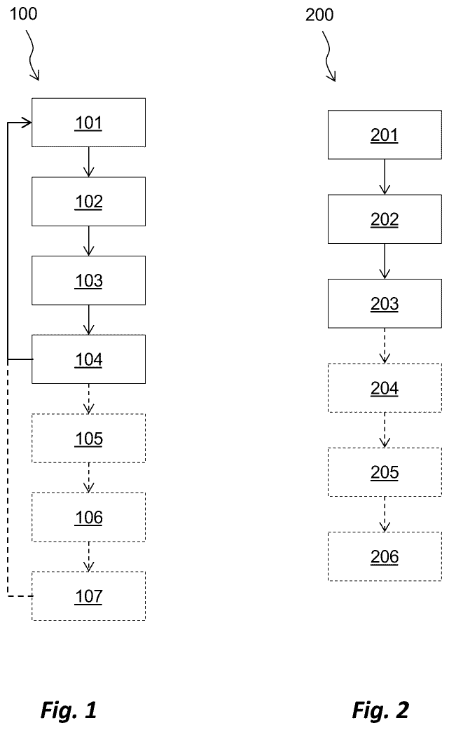

Dashed lines in FIG. 1 represent the steps of determining 105 transition data, reproducing 106 transition data, and repeatedly considering 107 motion data, particularly with transition data. The method can be repeated, at least partially or substantially in its entirety, as depicted. In particular, in this way, various scenarios can be generated for testing and/or optimizing a driver assistance system, and a test bench can be operated accordingly. The dashed steps shown are optional.

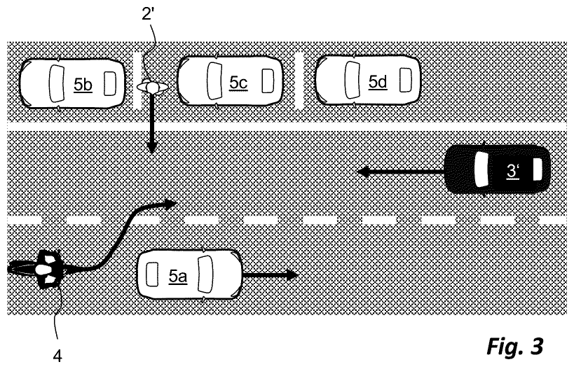

FIG. 2 shows a block diagram of another method 200 for operating a test bench.

In step 201, a virtual test environment is generated. In step 202, motion data, particularly with a motion capture system, are captured, and in step 203, a scenario is recorded. Steps 204, 205, 206 correspond to steps 105, 106, 107 of method 100 and are optional and therefore depicted with dashed lines, wherein transition data are determined, transition data are reproduced, and motion data are repeatedly considered in the steps.

Method 200 according to FIG. 2 differs from method 100 according to FIG. 1 essentially in that scenario data are recorded, which characterize a scenario. By means of an interface 22, in particular a user interface such as a motion capture system, motion data are captured and, together with the reactions of the driver assistance system, are taken into account again when generating the virtual test environment.

Preferably, method 200 can also be operated based on method 100, wherein the motion data captured in method 100 are passed on.

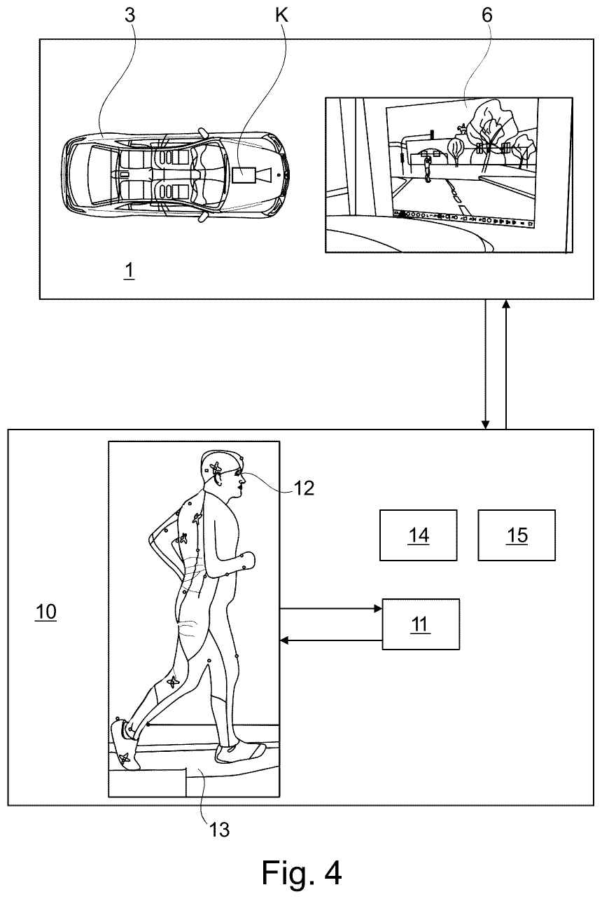

In FIG. 3, an exemplary virtual test environment is shown, which can be generated by methods 100, 200 for operating a test bench.

A virtual vehicle 3′ controlled by a driver assistance system is driving on the right lane. In addition to the lane, there are other vehicles 5b, 5c, 5d parked, through which the virtual pedestrian 2′ is not or only poorly detectable for the sensors of the driver assistance system.

Next to the virtual pedestrian 2′ and the parked vehicles 5b, 5c, 5d, there is another vehicle 5a in the environment of the virtual vehicle 3′ controlled by the driver assistance system, also called ego vehicle, which is approaching the virtual vehicle 3′ controlled by a driver assistance system on the other lane.

Behind this other vehicle 5a, a motorcycle rider 4 is driving. Whether he is perceptible in the environment of the virtual vehicle 3′ controlled by the driver assistance system cannot be inferred from FIG. 3. In the depicted test environment, the motorcycle rider 4 will try to overtake the other vehicle 5a on the other lane. At the same time, the virtual pedestrian 2′ crosses the road in the depicted scenario.

Depending on how the driver assistance system reacts or acts in the test environment, i.e., what driving behavior the driver assistance system exhibits in the test environment of the virtual vehicle 3′, a scenario will result that is more or less dangerous.

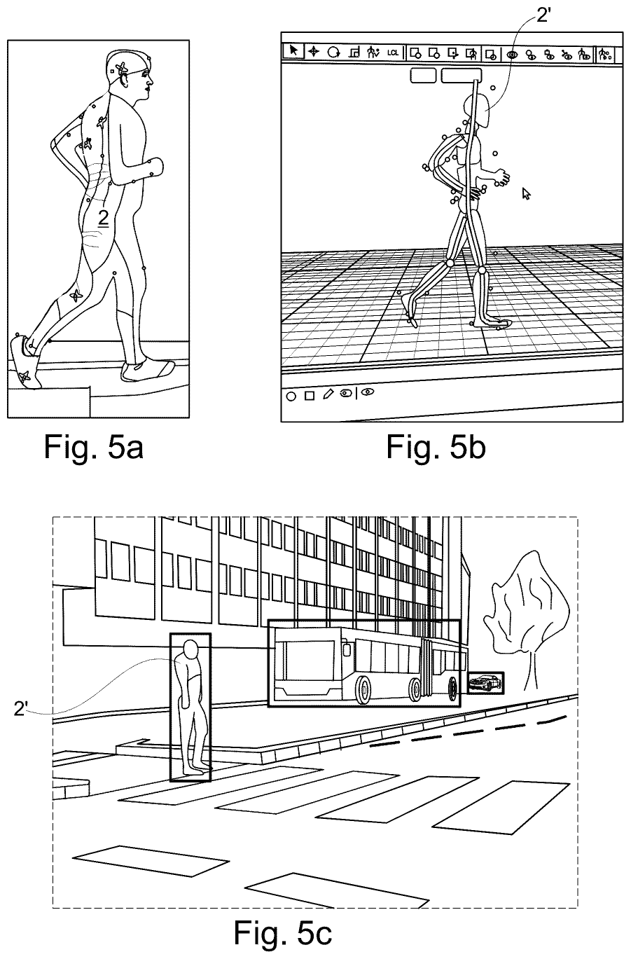

FIG. 4 shows an exemplary embodiment of a system 10 for operating a test bench 1 with a virtual test environment.

This system 10 preferably comprises simulation means 11 for generating a virtual test environment with at least one virtual living being 2′ and at least one virtual vehicle 3′.

In order to make a virtual living being 2′, in the example shown a pedestrian, controllable by a first user 2 as a road user 2′, the system 10 can further comprise a first user interface 13 and preferably a second user interface 12.

The at least one first user interface 13 can serve to output a virtual environment of the virtual pedestrian 2′ to a first user 2. The user interfaces 13 may be stimulation means such as an optical user interface, in particular a head-mounted device or a screen, and/or audio interfaces such as speakers and, optionally, devices with which the sense of balance of the respective user can be influenced.

The second user interface 12 is preferably configured to capture inputs from the respective user 2. This is preferably a motion capture system 12, which can capture the poses and movements of the user 2 via various sensors and, for example, a treadmill.

Furthermore, the system 10 preferably comprises storage means 14 for recording the captured motion data.

Furthermore, the system 10 preferably comprises a data memory 15 for providing scenario data which characterize a scenario in which the virtual pedestrian 2′ is located.

The simulation means 11 are preferably configured to simulate a virtual test environment of a virtual vehicle 3′ based on the scenario data. Furthermore, the simulation means 11 are preferably also configured to render this environment.

An interface 6 of the test bench 1 is finally configured to output the virtual test environment to a driver assistance system of the vehicle 3. Such an interface 6 can be a screen if the driver assistance system has an optical camera K, as shown in FIG. 4.

The means 11 for simulating calculate a response signal S′ based on a captured signal S and the simulated environment, which in turn is output to the camera K of the driver assistance system. In this way, the function of the driver assistance system can be tested. The response signal S′ can also be output to a radar of a driver assistance system via a radar simulator. Further environments can be simulated for a lidar, an ultrasound, or an infrared camera.

Depending on which components of a driver assistance system are to be tested, the simulated virtual test environment, as shown in FIG. 4, can be output to the sensor K of the driver assistance system by emulating signals. Alternatively, a signal can be generated which is fed directly into the data processing unit of the driver assistance system or a signal which is processed only by the software of the driver assistance system.

Preferably, the storage means 14 and the means for simulating 11 are part of a data processing device.

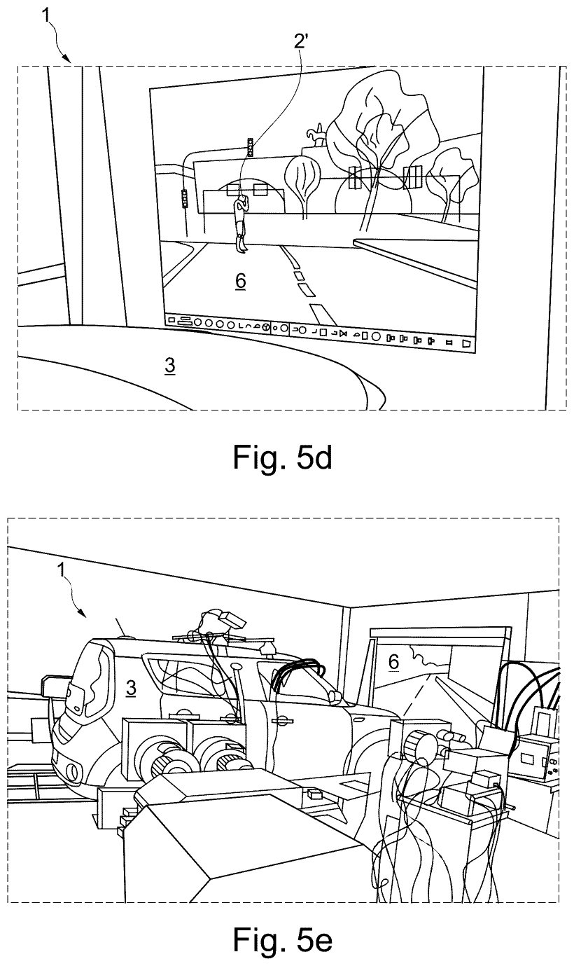

FIGS. 5a to 5e show embodiments of a system 10 with a motion capture system 12, wherein the system 10 is shown in particular in the step of capturing 103, 202 motion data, in which movements of the pedestrian 2 are captured via sensors.

In FIG. 5a, a pedestrian is equipped as a real living being 2 in such a way that his movements, especially the movements of parts of his anatomy, can be recorded.

The depicted person is on a treadmill, with which in particular movement sequences during locomotion can be simulated. Furthermore, in particular, the temporal course of a pose (of at least one part of an anatomical structure) can be captured and/or recorded.

This temporal course of a pose can be captured and/or recorded as motion data. These motion data can then, as shown in FIG. 5b, be transmitted to a virtual living being 2′, in particular an avatar. The virtual living being 2′ then performs the same or substantially the same movements as the real living being 2. In other words, the motion data captured by the real living being 2 can be transmitted to a virtual living being 2′, in particular an avatar, so that the avatar performs the same movements as the real living being 2.

When generating a virtual test environment in step 101, 201, the virtual living being 2′ is embedded in the test environment in such a way that the virtual living being 2′, in particular the avatar, at least substantially represents the same temporal sequence of poses in the virtual test environment.

In FIG. 5c, an exemplary virtual test environment is shown, which includes a pedestrian crossing, two lanes, wherein a bus and another vehicle located behind the bus are arranged on the opposite lane, as well as a virtual pedestrian 2′ at the beginning of the pedestrian crossing, which leads across the lane of the ego vehicle. Furthermore, in the depicted virtual test environment, objects already known or recognized by the driver assistance system are framed.

The view of the virtual pedestrian 2′ correlates with the view of the real person 2 in the motion capture system 12, this view being displayed to the person 2 in particular with a headset of augmented reality, a headset for virtual reality, or a headset for mixed reality (not shown in FIG. 5c).

The real living being 2 can then react to the situation or scenario in the virtual test environment, and this reaction is in turn represented in the virtual test environment by the captured motion data of the real living being 2 with the virtual living being 2′.

In FIG. 5d, a projection of the virtual test environment for sensors, in particular camera sensors, of the test specimen 3 on a test bench 1 is shown on a screen 6. In the test environment shown there, the virtual living being 2′ can be seen on the lane.

The test environment can, as shown in FIG. 5e as an exemplary embodiment, be presented to a test specimen 3, so that a driver assistance system associated with the test specimen 3 can detect the virtual living being 2′ by means of its sensors. For this purpose, FIG. 5e shows a part of a real vehicle as a test specimen 3 on a test bench 1, and before the vehicle 3 a projection 6 of the virtual test environment from the perspective of the virtual vehicle 3′.

It should be noted that the embodiments are merely examples that are not intended to limit the scope, application, and structure in any way. Rather, the foregoing description provides a guide for implementing at least one embodiment to a person skilled in the art, with various changes, particularly with regard to the function and arrangement of the described components, being possible without departing from the scope as determined by the claims and these equivalent combinations of features.

1. A method for creating a test event for a driver assistance system, the method including:
generating a virtual test environment that includes at least one virtual living being and at least one virtual vehicle, wherein the virtual living being is a virtual representation of a real living being and wherein that at least one virtual vehicle is a virtual representation of a vehicle with a driver assistance system;
capturing, with a motion capture system, motion data of a real living being interacting with a set of physical controls manipulatable to operate one or more parts of a first vehicle, the motion data describing a time history of a pose of the at least one part of an anatomical structure of the real living being;
recording the captured motion data; and
generating a test event for the driver assistance system based on a reaction of the driver that is captured within the motion data.

2. The method of claim 1, wherein the test event includes the motion data describing the time history of the pose and a first virtual stimulus of the virtual test environment.

3. The method of claim 1, wherein the first vehicle is a real vehicle or the virtual representation of the vehicle.

4. The method of claim 2, wherein creating the test event comprises:
storing the motion data in association with first video data that includes the first virtual stimulus and aspects of the virtual test environment.

5. The method of claim 2, wherein the motion data is collected while the real living being is interacting with the physical controls of the first vehicle and being stimulated by a second stimulus.

6. The method of claim 5, wherein generating the test event further comprises:
selecting the first virtual stimulus from multiple virtual stimuli of the virtual test environment, wherein the second stimulus is different from the first virtual stimulus.

7. The method of claim 5, wherein the second stimulus is a virtual stimulus, and wherein the test event includes the second stimulus and new motion data that is generated by changing at least one part of the anatomical structure of the real living being that is included in the motion data.

8. The method of claim 5, wherein changing the at least one part of the anatomical structure is performed based on an empirical quantile of the at least one part of the anatomical structure.

9. The method of claim 1, further including:
adding the test event to a training dataset; and
providing the test event as a test input to the driver assistance system.

10. The method of claim 1, wherein the motion data of the real living being is captured while the real living being is interacting with a sequence of virtual stimuli presented at a first speed and wherein the test event includes the sequence of virtual stimuli presented at a second speed that is faster or slower than the first speed.

11. The method of claim 1, wherein the motion data includes first captured motion data and second captured motion data, and wherein the method further comprises:
determining transition data between first captured motion data and second captured motion data, the transition data describing a temporal and/or spatial transition from the first captured motion data to the second captured motion data, and
wherein the test event includes the transition data reproduced at a time that is between the first captured motion data and the second captured motion data.

12. A method for testing a driver assistance system, the method including:
providing a test dataset that includes a test event, the test event comprising:
motion data describing a time history of a pose of at least one part of an anatomical structure of a real living being that is interacting with physical controls of a first vehicle at the time the motion data is captured; and
virtual simulation data that describes at least one virtual living being and at least one virtual vehicle, wherein the virtual living being is a virtual representation of the real living being and wherein that at least one virtual vehicle includes a driver assistance system; and
providing the test dataset as input to the driver assistance system.

13. The method of claim 12, wherein the driver assistance system includes a machine learning model and the method further includes:
training the machine learning model, based on the test dataset, to identify and execute autonomous interventions for a vehicle that reduce likelihood of a vehicle accident.

14. The method of claim 12, wherein the virtual simulation data of the test event includes a first virtual stimulus presented within a virtual test environment.

15. The method of claim 12, whether the first vehicle is either a real vehicle or the virtual representation of the vehicle.

16. The method of claim 14, wherein the motion data is collected while the real living being is being stimulated by a second stimulus that is different from the first stimulus included in the test event.

17. A system comprising:
one or more storage devices storing:
virtual simulation data that includes at least one virtual living being and at least one virtual vehicle, wherein the virtual living being is a virtual representation of a real living being and wherein that at least one virtual vehicle is a virtual representation of a vehicle with a driver assistance system; and
motion data of a real living being interacting with a set of physical control manipulatable to operate one or more parts of the vehicle; and
a software module, stored in the memory, configured to:
generate a test event for the driver assistance system by combining a subset of the motion data with a subset of the virtual simulation data, the subset of the motion data describing a time history of a pose of the at least one part of an anatomical structure of the real living being; and
test the driver assistance system based on the test event.

18. The system of claim 17, wherein the test event includes a first virtual stimulus described within the virtual simulation data and wherein the subset of the motion data is captured while the real living being is interacting with the physical controls of the vehicle and being stimulated by a second stimulus different from the first virtual stimulus.

19. The system of claim 17, wherein the subset of the motion data of the real living being is captured while the real living being is interacting with a sequence of virtual stimuli presented at a first speed and wherein the test event includes the sequence of virtual stimuli presented at a second speed that is faster or slower than the first speed.

20. The system of claim 17, wherein the software module is further configured to generate the test event at least in part by:
generating new motion data by changing at least one part of the anatomical structure of the real living being; and
storing the new motion in association with a subset of the virtual simulation data.
